(19) United States
(12) Patent Application Publication
(10) Pub. No.: US 2007/0268460 A1
(43) Pub. Date: Nov. 22, 2007

(54) Lens assembly in an offset projection system

(76) Inventors: Stephan R. Clark, Corvallis, OR (US); Scott Lerner, Corvallis, OR (US); Anurag Gupta, Tucson, AZ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/438,384

(22) Filed: May 22, 2006

(51) Int. Cl. G03B 21/26

(52) U.S. Cl. 353/34

(57) ABSTRACT

An assembly including a first lens having a first surface and a second surface, the first surface being a first convex surface, a second lens having a third surface and a fourth surface, the third surface adhered to the second surface, a third lens having a fifth surface and a sixth surface, the fifth surface adhered to the fourth surface, and a beamsplitter having a seventh surface adhered to the sixth surface is provided.

### BACKGROUND

Optical architectures of digital projectors typically include an illumination system, projection system, an optical modulator and one or more devices that couple the illumination system, projection system and the optical modulator. The illumination system illuminates the optical modulator. The optical modulator produces images by modulating the light falling across it by either reflecting or transmitting the light. The projection system images the optical modulator on the screen by capturing the modulated illumination of the optical modulator.

Generally, optical architectures have the optical axes of the projection and illumination paths either overlapping (across a portion of the system) or tilted substantially with respect to each other. For those systems that require or might benefit from a relatively on-axis or small incident angle illumination and projection paths on the optical modulator plane, such architectures may be inefficient, noisy, bulky or expensive. It would be desirable to be able to obtain high efficiency and low stray light in a compact package at a low cost in an optical architecture.

### SUMMARY

One form of the present invention provides an assembly including a first lens having a first surface and a second surface, the first surface being a first convex surface, a second lens having a third surface and a fourth surface, the third surface adhered to the second surface, a third lens having a fifth surface and a sixth surface, the fifth surface adhered to the fourth surface, and a beamsplitter having a seventh surface adhered to the sixth surface.

### BRIEF DESCRIPTION OF THE DRAWINGS

FIG. 1 is a block diagram illustrating an offset digital projection system according to one embodiment of the present invention.

FIG. 2A is a schematic diagram illustrating an offset digital projection system with a fold mirror according to one embodiment of the present invention.

FIG. 2B is a schematic diagram illustrating an offset digital projection system with a fold mirror according to one embodiment of the present invention.

FIG. 3A is a schematic diagram illustrating a coupling lens according to one embodiment of the present invention.

FIG. 3B is a schematic diagram illustrating a coupling lens according to one embodiment of the present invention.

FIG. 3C is a schematic diagram illustrating a coupling lens according to one embodiment of the present invention.

### DETAILED DESCRIPTION

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense.

As described herein, a coupling lens is provided for a digital projection system with common path projection and illumination optics. The coupling lens operates to minimize the amount of stray light in the projection system to increase the full on and full off contrast of the system. To do so, the coupling lens is configured to maximize a distance between the stop of the system and the surface of coupling lens that is nearest to the aperture stop by cementing together a group of lenses that form the coupling lens. The surface of the coupling lens that receives the illumination beam forms a relatively steep surface with respect to the illumination beam to reduce the Fresnel reflections that enter the projection path of the projection system. Further, the indices of refraction of the lenses and cements may be optimized to minimize ghosting in the system.

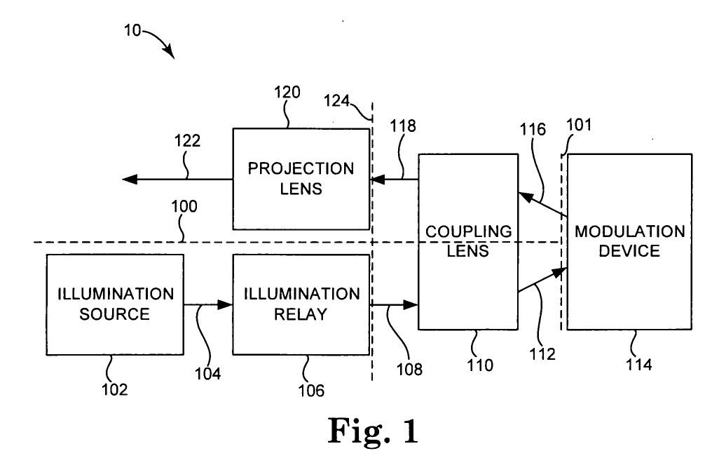

FIG. 1 is a block diagram illustrating one embodiment of an offset digital projection system 10. In projection system 10, an illumination source 102 generates and emits an illumination beam to an illumination relay 106 along an optical path 104. Illumination relay 106 integrates the illumination beam and provides the illumination beam to a coupling lens 110 along an illumination path 108 such that an optical axis of illumination path 108 is parallel or substantially parallel to a normal 100 to a plane 101 of a modulation device 114. Normal 100 is substantially perpendicular to plane 101, and plane 101 aligns with at least one modulating element (not shown) of modulation device 114. Coupling lens 110 directs and focuses the illumination beam onto modulation device 114 along an illumination path 112. Illumination relay 106 images illumination source 102 onto modulation device 114 via coupling lens 110 such that modulation device 114 is illuminated with minimum overfill. Coupling lens 110 directs the illumination beam onto modulation device 114 at a non-zero angle of incidence such that the illumination beam is telecentric. Coupling lens 110 is substantially centered with respect to modulation device 114.

Modulation device 114 modulates the illumination beam from coupling lens 110 according to an input signal, e.g., a computer or video input signal, (not shown) to form an imaging beam. The imaging beam is reflected from modulation device 114 through coupling lens 110 along an optical path 116. Coupling lens 110 telecentrically directs the imaging beam from modulation device 114 through a projection lens 120 along a projection path 118 such that an optical axis of projection path 118 is parallel or substantially parallel to normal 100 and the optical axis of illumination path 108. Projection lens 120 focuses and may zoom the imaging beam along an optical path 122 to cause still or video images to be formed on a screen or other display surface (not shown). Projection lens 120 images modulation device 114 through coupling lens 110 onto the screen or other display surface used for final display.

In projection system 10, illumination relay 106, coupling lens 110, and projection lens 120 are situated so as to minimize the overlap of the illumination and imaging beams along illumination path 108 and projection path 118. In particular, the illumination beam and the imaging beam each intersect different areas of an optical aperture stop plane 124 of the system such that the imaging beam is spatially separated from the illumination beam at aperture stop plane 124. Accordingly, illumination path 108 is effectively separated from projection path 118. In the embodiment of FIG. 1, coupling lens 110 includes all optical elements between aperture stop plane 124 and modulation device 114.

Illumination source 102 may be a mercury ultra high pressure, xenon, metal halide, or other suitable projector lamp that provides a monochromatic or polychromatic illumination beam. Modulation device 114 transmits or reflects selected portions of the illumination beam through coupling lens 110 and projection lens 120 in response to an image input signal (not shown) to cause images to be projected onto a screen or other surface. Modulation device 114 comprises at least one digital modulator such as a spatial light modulator like LCos, liquid crystal display (LCD), digital micromirror display (DMD) or other type. In one embodiment, modulation device 114 includes a separate digital modulator for each color, e.g., red, blue, and green.

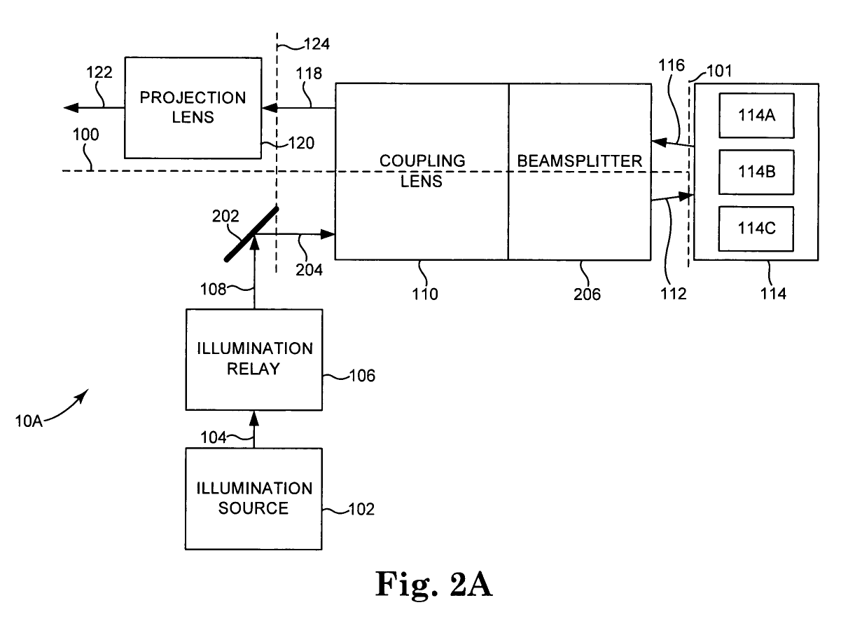

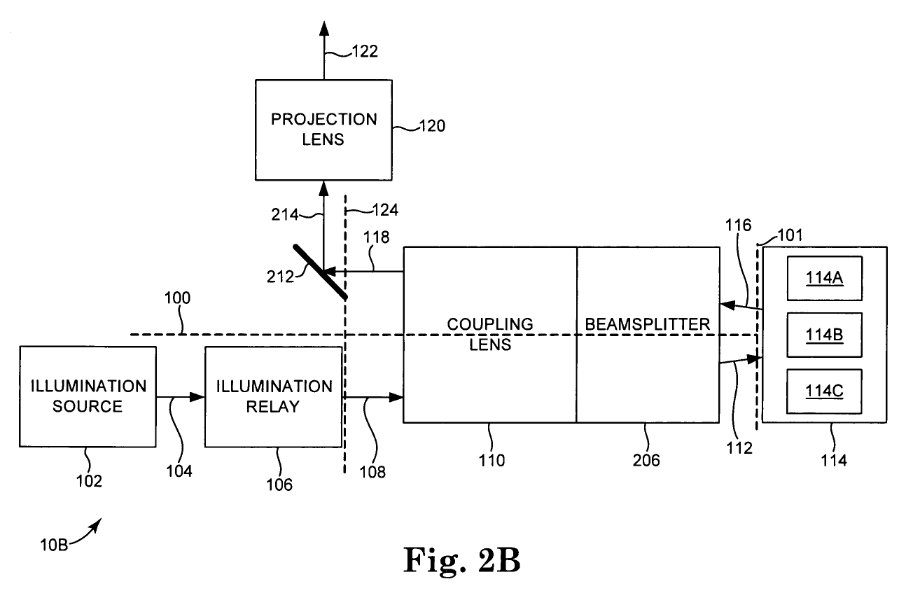

FIG. 2A is a schematic diagram illustrating an embodiment 10A of offset digital projection system 10 with a fold mirror 202. In projection system 10A, illumination source 102 generates and emits the illumination beam to the illumination relay 106 along an optical path 104. Illumination relay 106 provides the illumination beam to fold mirror 202.

Fold mirror 202 reflects the illumination beam from illumination relay 106 through coupling lens 110 along an illumination path 204 such that an optical axis of illumination path 204 of the illumination beam is parallel or substantially parallel to optical axis 100 of modulation device 114 between fold mirror 202 and coupling lens 110. In the embodiment shown in FIG. 2, fold mirror 202 reflects the illumination beam at an angle of approximately ninety degrees between the optical axis of illumination relay 106 and optical axis 100. In other embodiments, fold mirror 202 may be positioned differently to reflect the illumination beam at any non-zero angle between the optical axis of illumination relay 106 and optical axis 100.

Coupling lens 110 refracts and focuses the illumination beam onto modulation device 114 through a beamsplitter 206 along optical path 112. Beamsplitter 206 separates the illumination beam into separate components (e.g., red, blue, and green components) that are provided to different modulators 114A, 114B, and 114C of modulation device 114. Modulators 114A, 114B, and 114C may be set in any suitable arrangement with respect to beamsplitter 206. Beamsplitter 206 may be a dichroic prism, a dichroic plate, a dichroic x-cube, or other element configured to separate the illumination beam into separate components. Beamsplitter 206 may be omitted in embodiments where modulation device 114 includes a single modulator. Coupling lens 110 refracts illumination beam 202 onto modulation device 114 at a non-zero angle of incidence.

Modulation device 114 modulates the illumination beam from coupling lens 110 according to an input signal, e.g., a computer or video input signal, (not shown) to form an imaging beam. The imaging beam is reflected from modulation device 114 through beamsplitter 206 and into coupling lens 110 along optical path 116. Coupling lens 110 refracts the imaging beam from modulation device 114 through projection lens 120 such that the imaging beam travels along an optical axis of optical path 118 which is parallel or substantially parallel to normal 100 to plane 101 of modulation device 114 and an optical axis of illumination path 204 of the illumination beam between coupling lens 110 and pupil plane 124. Projection lens 120 focuses and may zoom the imaging beam along optical path 122 to cause still or video images to be formed on a screen or other display surface.

In projection system 10A, illumination relay 106, coupling lens 110, and projection lens 120 are situated so as to minimize the overlap of the illumination beam and the imaging beam along illumination path 204 and optical path 118. In particular, the illumination beam and the imaging beam each intersect different areas of aperture stop plane 124 of the system such that the imaging beam is spatially separated from the illumination beam at aperture stop plane 124. Accordingly, the illumination path is effectively separated from the projection path.

FIG. 2B is a schematic diagram illustrating an embodiment 10B of offset digital projection system 10 with a fold mirror 212. In projection system 10B, illumination source 102 generates and emits an illumination beam to illumination relay 106 along optical path 104. Illumination relay 106 integrates provides the illumination beam to coupling lens 110B along an illumination path 108 such that an optical axis of illumination path 108 is parallel or substantially parallel to normal 100 to plane 101 of modulation device 114 between illumination relay 106 and coupling lens 110.

Coupling lens 110, beamsplitter 206, and modulation device 114 operate as described with reference to FIG. 2A above. Coupling lens 110 refracts the imaging beam from modulation device 114 to fold mirror 212 such that the imaging beam travels along an optical axis of optical path 118 that is parallel or substantially parallel to normal 100 to plane 101 of modulation device 114 and an optical axis of optical path 108 of the illumination beam.

Fold mirror 212 reflects the imaging beam from coupling lens 110 into projection lens 120 along an optical path 214. In the embodiment shown in FIG. 2B, fold mirror 212 reflects the imaging beam at an angle of approximately ninety degrees between normal 100 and an optical axis of optical path 214. In other embodiments, fold mirror 212 may be positioned differently to reflect the imaging beam at any non-zero angle between normal 100 and the optical axis of optical path 214. Projection lens 120 focuses and may zoom the imaging beam from fold mirror 212 along optical path 122 to cause still or video images to be formed on a screen or other display surface.

In projection system 10B, illumination relay 106, coupling lens 110, and projection lens 120 are situated so as to minimize the overlap of the illumination and imaging beams along illumination path 108 and projection path 118. In particular, the illumination beam and the imaging beam each intersect different areas of aperture stop plane 124 of the system such that the imaging beam is spatially separated from the illumination beam at aperture stop plane 124. Accordingly, illumination path 108 is effectively separated from projection path 118.

In other embodiments, fold mirrors 202 (FIG. 2A) and 212 (FIG. 2B) may replaced with other reflective surfaces. In addition, a system may include fold mirrors in both the illumination and projection paths in other embodiments.

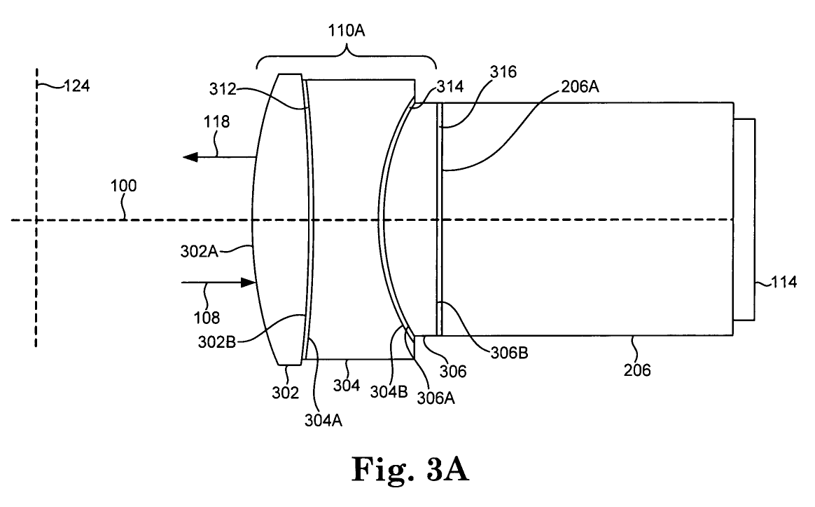

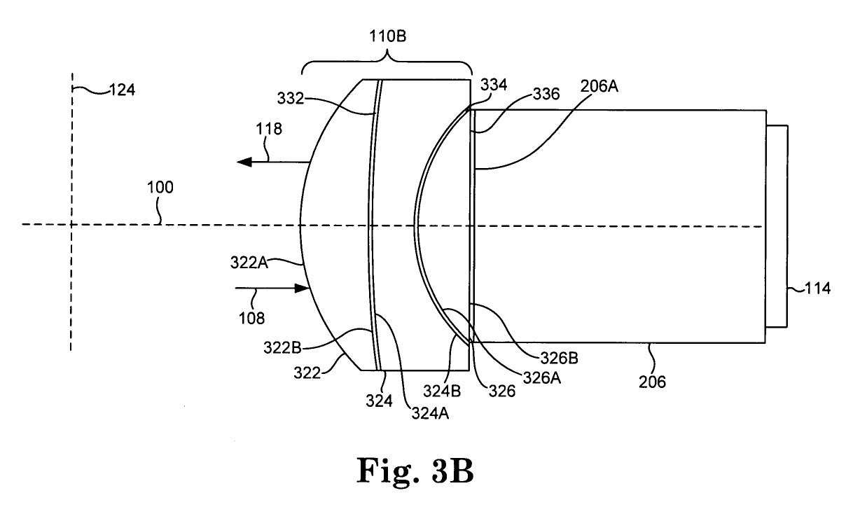

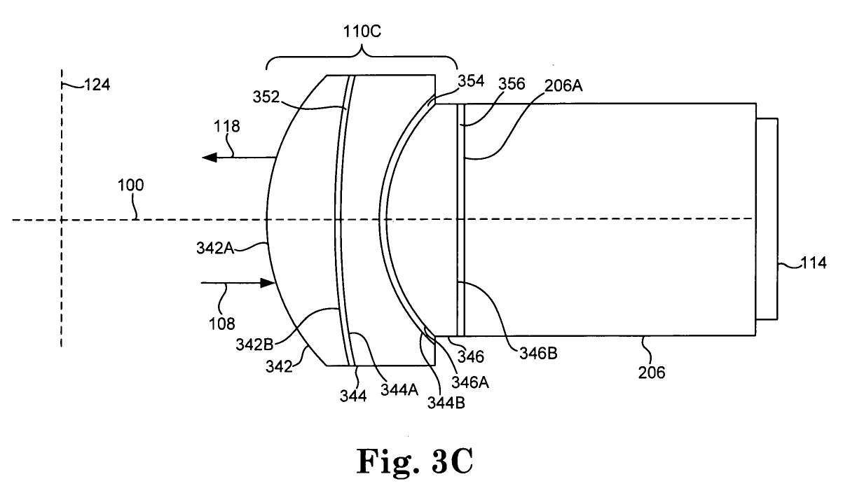

Coupling lens 110 may be configured according to embodiments 110A, 110B, and 110C of FIGS. 3A, 3B, and 3C, respectively, to minimize the amount of stray light that reflects off of coupling lens 110 from the illumination path into the projection path of projection system 10. Embodiments 110A, 110B, and 110C of coupling lens 110 are also configured to maximize a distance between aperture stop plane 124 and the surface of coupling lens that is nearest to aperture stop plane 124 by cementing combinations of lenses together. Embodiments 110A, 110B, and 110C are further configured with a relatively steep surface lens that is nearest to pupil plane 124.

FIG. 3A is a schematic diagram illustrating embodiment 110A of coupling lens 110. Coupling lens 110A includes lenses 302, 304, and 306 where lens 306 is adhered to a planar surface 206A of beamsplitter 206. Beamsplitter 206 is adhered to modulation device 114.

Lens 302 is a biconvex lens with a spherical convex surface 302A and a spherical convex surface 302B. Lens 302 receives the illumination beam along Illumination path 108 and refracts the illumination beam into lens 304. Surface 302A forms a relatively steep surface with respect to the illumination beam to minimize the amount of light from the illumination beam that reflects off of surface 302A an into projections lens 120. Lens 304 is a biconcave lens with a spherical concave surface 304A and a spherical concave surface 304B. Lens 304 receives the illumination beam from lens 302 and refracts the illumination beam into lens 306. Lens 306 is a piano-convex lens with a spherical convex surface 306A and a planar surface 306B. Lens 306 receives the illumination beam from lens 304 and refracts the illumination beam into beamsplitter 206.

Beamsplitter 206 splits the illumination beam into separate components and refracts each component onto a suitable modulator of modulation device 114. Each modulator modulates the illumination beam from beamsplitter 206 according to an input signal, e.g., a computer or video input signal, (not shown) to form an imaging beam. The imaging beams are reflected from the modulators and refracted by beamsplitter 206 to combine into a single imaging beam. Lens 306 receives the combined imaging beam and refracts the imaging beam into lens 304. Lens 304 receives the imaging beam from lens 306 and refracts the imaging beam into lens 302. Lens 302 receives the imaging beam from lens 304 and refracts the imaging beam along projection path 118.

The cements that adhere lenses 302, 304, 306, and beamsplitter 206 are chosen to minimize Fresnel reflections and increase the full on and full off contrast of projection system 10. In particular, the cements are chosen to match the indices of refraction of lenses with equal indices of refraction and approximate the average of the indices of refraction of lenses with unequal indices of refraction.

Surfaces 302B and 304A have an equal or approximately equal radius of curvature and are adhered together at an interface 312 using cement that has an index of refraction that is between an index of refraction of lens 302 and an index of refraction of lens 304. Similarly, surfaces 304B and 306A have an equal or approximately equal radius of curvature and are adhered together at an interface 314 using cement that has an index of refraction that is between an index of refraction of lens 304 and an index of refraction of lens 306. Further, surfaces 306B and 206A are planar or substantially planar and are adhered together at an interface 316 using cement that has an index of refraction that is equal or approximately equal to the indices of refraction of lens 306 and beamsplitter 206.

In one embodiment, lenses 302 and 306 and beamsplitter 206 have equal or approximately equal indices of refraction, and lens 304 has an index of refraction that is higher than the indices of refraction of lenses 302 and 306 and beamsplitter 206. In other embodiments, the indices of refraction of lenses 302, 304, and 306 and beamsplitter 206 may have other relationships.

In one embodiment, coupling lens 110A follows the lens prescription of Table 1. In another embodiment, coupling lens 110A follows the lens prescription of Table 2. In other embodiments, coupling lens 110A follows other lens prescriptions.

TABLE 1

| | RADIUS OF | THICKNESS | INDEX OF |
|---|---|---|---|
| SURFACE | CURVATURE | (mm) | REFRACTION |
| 302A | 26.659057 | 8.471674 | 1.51680 |
| 302B/304A | −101.904755 | 4.499952 | 1.61293 |
| 304B/306A | 15.531690 | 9.609135 | 1.51680 |
| 306B/206A | Infinity | 31.257110 | 1.51680 |

TABLE 2

| | RADIUS OF | THICKNESS | INDEX OF |
|---|---|---|---|
| SURFACE | CURVATURE | (mm) | REFRACTION |
| 302A | 25.479300 | 9.63730 | 1.51680 |
| 302B/304A | −100.001100 | 4 | 1.61293 |
| 304B/306A | 15.376700 | 11.173270 | 1.51680 |
| 306B/206A | Infinity | 31.260000 | 1.51680 |

FIG. 3B is a schematic diagram illustrating embodiment 110B of coupling lens 110. Coupling lens 110B includes lenses 322, 324, and 326 where lens 326 is adhered to planar surface 206A of beamsplitter 206. Beamsplitter 206 is adhered to modulation device 114.

Lens 322 is a convex-concave lens with an even aspherical convex surface 322A and a spherical concave surface 322B. Lens 322 receives the illumination beam along Illumination path 108 and refracts the illumination beam into lens 324. Surface 322A forms a relatively steep surface with respect to the illumination beam to minimize the amount of light from the illumination beam that reflects off of surface 322A an into projections lens 120. Lens 324 is a convex-concave lens with a spherical convex surface 324A and a spherical concave surface 324B. Lens 324 receives the illumination beam from lens 322 and refracts the illumination beam into lens 326. Lens 326 is a plano-convex lens with a spherical convex surface 326A and a planar surface 326B. Lens 326 receives the illumination beam from lens 324 and refracts the illumination beam into beamsplitter 206.

Beamsplitter 206 splits the illumination beam into separate components and refracts each component onto a suitable modulator of modulation device 114. Each modulator modulates the illumination beam from beamsplitter 206 according to an input signal, e.g., a computer or video input signal, (not shown) to form an imaging beam. The imaging beams are reflected from the modulators and refracted by beamsplitter 206 to combine into a single imaging beam. Lens 326 receives the combined imaging beam and refracts the imaging beam into lens 324. Lens 324 receives the imaging beam from lens 326 and refracts the imaging beam into lens 322. Lens 322 receives the imaging beam from lens 324 and refracts the imaging beam along projection path 118.

The cements that adhere lenses 322, 324, 326, and beamsplitter 206 are chosen to minimize Fresnel reflections and increase the full on and full off contrast of projection system 10. In particular, the cements are chosen to match the indices of refraction of lenses with equal indices of refraction and approximate the average of the indices of refraction of lenses with unequal indices of refraction.

Surfaces 322B and 324A have an equal or approximately equal radius of curvature and are adhered together at an interface 332 using cement that has an index of refraction that is between an index of refraction of lens 322 and an index of refraction of lens 324. Similarly, surfaces 324B and 326A have an equal or approximately equal radius of curvature and are adhered together at an interface 334 using cement that has an index of refraction that is between an index of refraction of lens 324 and an index of refraction of lens 326. Further, surfaces 326B and 206A are planar or substantially planar and are adhered together at an interface 336 using cement that has an index of refraction that is equal or approximately equal to the indices of refraction of lens 326 and beamsplitter 206.

In one embodiment, lenses 322 and 326 and beamsplitter 206 have equal or approximately equal indices of refraction, and lens 324 has an index of refraction that is higher than the indices of refraction of lenses 322 and 326 and beamsplitter 206. In other embodiments, the indices of refraction of lenses 322, 324, and 326 and beamsplitter 206 may have other relationships.

In one embodiment, coupling lens 110B follows the lens prescription of Table 3. In other embodiments, coupling lens 110B follows other lens prescriptions.

TABLE 3

| | RADIUS OF | THICKNESS | INDEX OF |
|---|---|---|---|
| SURFACE | CURVATURE | (mm) | REFRACTION |
| 322A | Aspherical | 6.070206 | 1.43875 |
| 322B/324A | 116.822626 | 3.993753 | 1.688.93 |
| 324B/326A | 15.340970 | 31.911897 | 1.51680 |
| 326B/206A | Infinity | | 1.51680 |

In Table 3, the thickness shown for lens 326 includes the thickness of beamsplitter 206.

Surface 322A of lens 322 further follows the lens prescription of Table 4.

TABLE 4

| BASE RADIUS OF | |
|---|---|
| CURVATURE | 17.197986 |
| 4^{TH} ORDER TERM | −1.193542E−05 |
| 6^{TH} ORDER TERM | 1.502243E−08 |
| 8^{TH} ORDER TERM | −6.987755E−10 |
| 10^{TH} ORDER TERM | 3.801264E−12 |
| 12^{TH} ORDER TERM | −9.793144E−15 |
| 14^{TH} ORDER TERM | 0.00 |

FIG. 3C is a schematic diagram illustrating embodiment 110C of coupling lens 110. Coupling lens 110C includes lenses 342, 344, and 346 where lens 346 is adhered to planar surface 206A of beamsplitter 206. Beamsplitter 206 is adhered to modulation device 114.

Lens 342 is a convex-concave lens with an aspherical convex surface 342A and a spherical concave surface 342B. Lens 342 receives the illumination beam along Illumination path 108 and refracts the illumination beam into lens 344. Surface 342A forms a relatively steep surface with respect to the illumination beam to minimize the amount of light from the illumination beam that reflects off of surface 342A an into projections lens 120. Lens 344 is a convex-concave lens with a spherical convex surface 324A and a spherical concave surface 324B. Lens 344 receives the illumination beam from lens 342 and refracts the illumination beam into lens 346. Lens 346 is a plano-convex lens with a spherical convex surface 346A and a planar surface 346B. Lens 346 receives the illumination beam from lens 344 and refracts the illumination beam into beamsplitter 206.

Beamsplitter 206 splits the illumination beam into separate components and refracts each component onto a suitable modulator of modulation device 114. Each modulator modulates the illumination beam from beamsplitter 206 according to an input signal, e.g., a computer or video input signal, (not shown) to form an imaging beam. The imaging beams are reflected from the modulators and refracted by beamsplitter 206 to combine into a single imaging beam. Lens 346 receives the combined imaging beam and refracts the imaging beam into lens 344. Lens 344 receives the imaging beam from lens 346 and refracts the imaging beam into lens 342. Lens 342 receives the imaging beam from lens 344 and refracts the imaging beam along projection path 118.

The cements that adhere lenses 342, 344, 346, and beamsplitter 206 are chosen to minimize Fresnel reflections and increase the full on and full off contrast of projection system 10. In particular, the cements are chosen to match the indices of refraction of lenses with equal indices of refraction and approximate the average of the indices of refraction of lenses with unequal indices of refraction.

Surfaces 342B and 344A have an equal or approximately equal radius of curvature and are adhered together at an interface 352 using cement that has an index of refraction that is between an index of refraction of lens 342 and an index of refraction of lens 344. Similarly, surfaces 344B and 346A have an equal or approximately equal radius of curvature and are adhered together at an interface 354 using cement that has an index of refraction that is between an index of refraction of lens 344 and an index of refraction of lens 346. Further, surfaces 346B and 206A are planar or substantially planar and are adhered together at an interface 356 using cement that has an index of refraction that is equal or approximately equal to the indices of refraction of lens 346 and beamsplitter 206.

In one embodiment, lenses 342 and 346 and beamsplitter 206 have equal or approximately equal indices of refraction, and lens 344 has an index of refraction that is higher than the indices of refraction of lenses 342 and 346 and beamsplitter 206. In other embodiments, the indices of refraction of lenses 342, 344, and 346 and beamsplitter 206 may have other relationships.

In one embodiment, coupling lens 110C follows the lens prescription of Table 5. In other embodiments, coupling lens 110C follows other lens prescriptions.

TABLE 5

| | RADIUS OF | THICKNESS | INDEX OF |
|---|---|---|---|
| SURFACE | CURVATURE | (mm) | REFRACTION |
| 342A | Aspherical | 7.5 | 1.46008 |
| 342B/344A | 44.4846 | 3.7 | 1.78472 |
| 344B/346A | 16.01 | 8 | 1.46008 |
| 346B/206A | Infinity | | 1.46008 |

With the lens prescription of Table 5, beamsplitter 206 may have any suitable thickness.

Surface 342A of lens 342 further follows the lens prescription of Table 6.

TABLE 6

| BASE RADIUS OF | |
|---|---|
| CURVATURE | 17.4502 |
| 4^{TH} ORDER TERM | −1.30E−05 |
| 6^{TH} ORDER TERM | 3.20E−08 |
| 8^{TH} ORDER TERM | −7.70E−10 |
| 10^{TH} ORDER TERM | 3.80E−12 |
| 12^{TH} ORDER TERM | −8.60E−15 |
| 14^{TH} ORDER TERM | −9.80E−19 |

Embodiments 110A, 110B, and 110C may advantageously minimize the amount of stray light that is reflected into the projection path of projection system 10 by maximizing the distance between pupil plane 124 and the surface of coupling lens 110 that is nearest to aperture stop plane 124 (i.e., surface 302A, surface 322A, and surface 342A). The distance is maximized by cementing the lenses in each embodiment together. In addition, the curvatures of the lenses in each embodiment 110A, 110B, and 110C forms a relatively steep surface with respect to the illumination beam to reduce the Fresnel reflections that enter the projection path. As a result, the full on and full off contrast of projection system 10 may be increased. Further, the indices of refraction of the lenses and cements may be optimized as described above to minimize ghosting in the system.

An offset optical architecture as described herein may effectively separate the illumination and projection paths while maintaining the optical performance and highest possible efficiency and minimizing stray light. This architecture may also avoid complex and expensive optical components and may allow for a compact package that has a maximum number of small sized lenses to achieve a low cost compact system.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the optical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. An assembly comprising:
a first lens having a first surface and a second surface, the first surface being a first convex surface;
a second lens having a third surface and a fourth surface, the third surface adhered to the second surface;
a third lens having a fifth surface and a sixth surface, the fifth surface adhered to the fourth surface; and
a beamsplitter having a seventh surface adhered to the sixth surface.

2. The assembly of claim 1 wherein the second surface is a second convex surface and the third surface is a concave surface.

3. The assembly of claim 1 wherein the second surface is a concave surface and the third surface is a second convex surface.

4. The assembly of claim 1 wherein the fourth surface is a concave surface and the fifth surface is a second convex surface.

5. The assembly of claim 1 wherein the sixth surface is a first planar surface and the seventh surface is a second planar surface.

6. The assembly of claim 1 wherein the second lens has an index of refraction that is greater than an index of refraction of the first lens and an index of refraction of the third lens.

7. The assembly of claim 6 wherein the third surface is adhered to the second surface and the fifth surface is adhered to the fourth surface with cement that has an index of refraction that is between the index of refraction of the first lens and the index of refraction of the second lens.

8. The assembly of claim 6 wherein the seventh surface is adhered to the sixth surface with cement that has an index of refraction that is approximately equal to the index of refraction of the third lens and an index of refraction of the beamsplitter.

9. A projection system comprising:
an illumination relay;
a coupling lens including a first lens, a second lens adhered to the first lens, and a third lens adhered to the second lens;
a beamsplitter adhered to the third lens;
a modulation device; and
a projection lens;
wherein the illumination relay is configured to provide an illumination beam to the first lens along an illumination path having a first optical axis, wherein the first lens is configured to direct the illumination beam through the second lens the third lens, and the beamsplitter onto the modulation device, wherein the modulation device is configured to modulate the illumination beam to form an imaging beam and reflect the imaging beam into the beamsplitter and the third lens, wherein the third lens is configured to direct the imaging beam through the second lens and the first lens into the projection lens along a projection path having a second optical axis such that the second optical axis is substantially parallel and offset with the first optical axis.

10. The projection system of claim 9 wherein the illumination beam intersects a first area of an aperture stop plane formed by the projection lens, and wherein the imaging beam intersects a second area of the aperture stop plane that is substantially separate from the first area.

11. The projection system of claim 9 further comprising:
a fold mirror configured to reflect the illumination beam from the illumination relay to the coupling lens.

12. The projection system of claim 9 further comprising:
a fold mirror configured to reflect the imaging beam from the coupling lens to the projection lens.

13. The projection system of claim 9 wherein the first lens has a convex surface and a concave surface, and wherein the concave surface is adhered to the second lens.

14. The projection system of claim 9 wherein the first lens has a first convex surface and a second convex surface, and wherein the second convex surface is adhered to the second lens.

15. The projection system of claim 9 wherein the second lens has an index of refraction that is greater than an index of refraction of the first lens and an index of refraction of the third lens.

16. A method comprising:
providing an illumination relay configured to provide an illumination beam along an illumination path having a first optical axis;
providing a modulation device configured to modulate the illumination beam to form an imaging beam; and
providing a lens assembly having a first lens, a second lens adhered to the first lens, and a third lens adhered to the second lens, the lens assembly configured to direct the illumination beam onto the modulation device and direct the imaging beam into a projection lens along a projection path having a second optical axis such that the second optical axis is substantially parallel with the first optical axis.

17. The method of claim 16 wherein the illumination beam intersects a first area of a pupil plane of the lens assembly, and wherein the imaging beam intersects a second area of the pupil plane that is substantially separate from the first area.

18. The method of claim 16 further comprising:
providing a beamsplitter adhered to the third lens and configured to direct the illumination beam from the lens assembly onto the modulation device and direct the imaging beam from the modulation device through the lens assembly.

19. The method of claim 16 further comprising:
providing a fold mirror configured to reflect the illumination beam from the illumination relay to the coupling lens.

20. The method of claim 16 further comprising:
providing a fold mirror configured to reflect the projection beam from the coupling lens to the projection lens.
